(19) United States
(12) Patent Application Publication
(10) Pub. No.: US 2014/0245382 A1
(43) Pub. Date: Aug. 28, 2014

(54) SYSTEM AND METHOD FOR DEVELOPING AND USING TRUSTED POLICY BASED ON A SOCIAL MODEL

(71) Applicant: CONTENTGUARD HOLDINGS, INC., Wilmington, DE (US)

(72) Inventors: Tejinder Pal Pannu, Fremont, CA (US); Eddie J. Chen, Rancho Palos Verdes, CA (US); Charles P. Gilliam, Darien, CT (US); Michael Raley, Downey, CA (US)

(73) Assignee: CONTENTGUARD HOLDINGS, INC., Wilmington, DE (US)

(21) Appl. No.: 14/273,078

(22) Filed: May 8, 2014

Related U.S. Application Data
(63) Continuation of application No. 11/116,432, filed on Apr. 28, 2005, now abandoned.

(51) Int. Cl. H04L 29/06

(52) U.S. Cl. CPC H04L 63/20; H04L 63/08
USPC 726/1; 726/3; 726/7

(57) ABSTRACT

A trust policy is constructed based upon a social relationship between real-world entities. The trust policy may determined based upon a social network and social network maps. The social network map provides a framework to determine social distances. The trust policy provides quick and secure access to desired or trusted nodes while providing security from entities outside the trusted sphere of nodes. The trust policy determined by the social distance may be used for various types of applications including filtering unwanted e-mail, providing secure access to resources, and accessing protected services. File sharing, referral querying, advertisement targeting, announcement targeting, access control, and various applications may be limited using the constructed trust policy.

### RELATED APPLICATION DATA

This application is a Continuation of application Ser. No. 11/116,432, filed on Apr. 28, 2005, now pending, the disclosure of which is hereby incorporated herein by reference in its entirety.

### FIELD OF THE INVENTION

The present invention relates to the field of trusted networks. More particularly, it relates to systems and methods for developing and using trust policies based on social distance that may be used to enforce computational requests. The present invention details the development, management, and use of a trust policy based on social distance in a social network.

### BACKGROUND OF THE INVENTION

In recent years, networks and interconnectivity of individuals, groups, and organizations has taken hold. The Internet connects the world by joining billions of connected nodes that represent various entities. Applications such as the world wide web, electronic mail, instant messaging, chat rooms, and other peer-to-peer solutions allow direct contact between the nodes. The exponential increase in communications capabilities provided by peer-to-peer and other networks also resulted in too much connectivity, and too much access. Many applications now exist where a node would like to control its accessibility and visibility to other nodes. In many cases a particular node would like to limit its visibility to small subsets of the world-wide Internet community. Relationships based on trust, discretion, association, and simple preferences improves the quality and relevance of the information exchanged.

In recent years, the phenomenon of social networks has become common-place. Social networks may be described as the mapping of relationships and information flow between associated people, groups, companies, and the like. Similarly, social distance may be thought of as the degree of intimacy that prevails between people, groups, companies, and the like. The term “associated” as used herein implies a relationship of any type. Virtual private networks connect nodes by public network paths, while encryption and other security mechanisms are employed to make the virtual network private. For example, a number of systems enable the creation of networks using the Internet as the data-transporting medium. These systems use encryption and other security mechanisms to ensure that only authorized users can access the network and that the data cannot be intercepted. Internet services that provide virtual networks include Friendster®, Linkedin™, and Tribe®. These services have become household names. With millions of members, these virtual network provider services have created huge constellations of social networks that are used by the members to interact socially with other members.

In addition to networks used for strictly social purposes, other types of peer-to-peer networks are becoming more and more important. For instance, grid computing is being used more widely, especially in academic environments, to enable multiple computers to collaborate on a computing projects by providing seamless access to wide-area distributed resources.

Currently, social networks are created through explicit confirmation of social relationships by everyone in the social network. The purpose of the conventional systems is to map the existing, real-world human relationships in a computer model and make the mapped model available to the members of the network. The members can broaden, enhance, and explore new real-world relationships based on the computer model.

Previous attempts to address this problem included the use of secure Web sites and application-specific Web sites. These configurations typically provided secure access upon verification and authentication and resulted in increased costs, additional maintenance, more intrusive administration, and lack of flexibility. Conventional intranets and virtual private networks provide secure networks to peers, but through higher cost, less flexibility, and greater administrative oversight.

What is needed is a system and a method whereby nodes can communicate and interact through a wide range of applications while providing control over the distribution of information between the nodes and the degree to which distributed information may be attributed to a particular node.

### SUMMARY OF THE INVENTION

The present invention relates to a system and method for developing and using trust policies based on social distance. The present invention provides a simple, powerful, and elegant manner in which social distance may be used to construct a social distance network map and establish a trust policy based upon the constructed map. The trust policy may then be used to provide quick and secure access to desired or trusted nodes while providing a measure of security from entities outside the trusted sphere of nodes. Likewise, the trust policy may be established to provide different levels of access, or different degrees of rights, based upon different social distances. The present invention enables creation of a social distance map and employs methods to determine the social distance between associated entities who are part of the social network. The trust policy determined by the social distance map may be used for various types of applications including SPAM filtering, resource and file sharing, referral querying, advertisement targeting, announcement targeting, access control, and the like. Additionally, the present invention to describe how a trust policy based on the social distance map can be used for various types of applications.

### BRIEF DESCRIPTION OF THE DRAWING(S)

The above-mentioned and other features of this invention and the manner of attaining them will become more apparent, and the invention itself will be better understood, by reference to the following description of embodiments of the invention taken in conjunction with the accompanying figures where:

FIG. 1 illustrates a simple social network map that involves only four individuals.

FIG. 2 illustrates an example social network map in accordance with the present invention.

FIG. 3A illustrates a detailed example of a social distance map in accordance with the present invention.

FIG. 3B depicts an example of a social distance map as shown in FIG. 3A in a table for storage in a computer memory device.

FIG. 4 is a flow diagram illustrating the calculation of the social distance between two peers within a social network in accordance with the present invention.

FIG. 5 illustrates an exemplary system for creating a social network map and a social distance map in accordance with the present invention.

FIG. 6 illustrates the creation of a personal trust network through a register/confirm mechanism.

FIG. 7 illustrates a method for creating a social distance map through a register/confirm method.

FIG. 8 illustrates a social distance network created as the result of a register/confirm method in accordance with the present invention.

FIG. 9 provides an example schematic of a SPAM filtering system that uses a social distance map on a remote server to detect SPAM e-mails in accordance with the present invention.

FIG. 10 illustrates a method that can be used by SPAM software to filter e-mails according to the policy setting and the social distance queries sent to the server in accordance with the present invention.

FIG. 11 illustrates a regulated resource sharing application based on a social network.

### DETAILED DESCRIPTION OF THE INVENTION

The invention is described in detail with particular reference to certain preferred embodiments, but within the spirit and scope of the invention, it is not limited to such embodiments. It will be apparent to those of skill in the art that various features, variations, and modifications can be included or excluded, within the limits defined by the claims and the requirements of a particular use.

The present invention extends the functionality of current methods and systems used to employ social networks by creating a trust policy that may be used for a variety of applications including unwanted e-mail filtering, resource and file sharing, referral querying, advertisement targeting, announcement targeting, access control, and the like. The system and method of the present invention has many advantages over prior systems, because the social distance network maps and their elemental structures provided by the present invention significantly reduce the locating times and processing costs required while providing improved consistency and reliability in optimizing network access methods.

Instead of simply finding new real-world friendships and enhancing existing ones, the present invention uses real-world relationships mapped into computer models to leverage the inherent trust among various members who are part of a social network to provide a trust policy that may be used in applications in a variety of fields, such as digital rights management (DRM), e-mail, access control lists, file sharing, computer service sharing, and the like. The trust policy provides a guide for permitting others access to a user node in an effort to manage and control information exchanges. The trust policy is based on social distance, or the degree of intimacy that prevails between individual nodes. Likewise, these social distances are mapped into a social network that describes the relationship and information flow between people, groups, businesses, corporations, and other entities that exist as nodes on the network. Nodes on the network are the physical devices that represent associated entities such as persons, companies, friends, peers, or the like that form a relationship. In fields such as DRM, many applications require a trust model to regulate how, by whom, and when services may be accessed. The present invention uses a computer model of real-world relationships to leverage the trust inherent in those relationships to enhance the control of these systems.

If one individual is socially connected to another individual through one or more friends, there is an inherent trust relationship between the individuals. For example, if Joe is a direct friend of Bob, Joe can trust Bob. If Bob is also a direct friend of Jane, Joe can have some level of trust in Jane, because she is trusted by Bob. This trust relationship, as identified and quantified, may be used in many applications that require a trust policy.

This invention uses the terms “social” and “friends” in the broadest sense in that “social” is used in social network and social distance as based on any kind of relationship. Trust is inherent in many types of relationships, and the inherent trust relationships encompass social networks in the present invention. For example, the present invention applies to situations where people have a business relationship, a friendship, or any other type of association (such as vendor/vendee relationships, political affiliations, shared hobbies, occupation, geography, academic endeavors, and on the like). The entities that comprise the relationship are “associated entities.”

Similarly, “friends” may be two associated entities with a relationship of any kind A “friend” need not be a single individual but may be a set of individuals grouped based on some attribute. For example, a “friend” can be all persons who work in a particular company, belong to a common organization, or reside in a certain geographic location. Also, a “friend” may be a set composed of all e-mail senders with a certain attribute, such as all senders with an address from mycompany.com. In this example, the mycompany.com address is the attribute of interest, but the attribute of interest can be any part of the address. For example, a Russian person may designate any person with an e-mail address ending in “.ru” as a “friend.”

As used in the present invention, a “friend” can be any type of entity, not necessarily a person, and “friend” and “associated entity” are synonymous, as is a “user.” For example, an “associated entity” may be a unique device identified in some way (such as a serial number), a kind of device, a set of computing devices operating within a local area network, or a collection of devices identified in some manner. A “friend” or “associated entity” or “user” of a social network may be another social network. An “associated entity” or “friend” as used in the present invention may be represented as a node on the social network map.

### I. Determining Trust

To establish the trust policy for a particular social network, the amount of trust is quantified, and the amount of trust is then tied to the social distance map, which can be stored on a memory device in various formats. In this fashion, the level of trust between two associated entities is determined and a construct of the levels of trust is embodied by the relationships of the nodes evidenced on the social distance map. Trust is a key component in each of the applications described above. There are two major aspects to the trust associated with social maps, namely the amount of trust that exists between any two nodes of a social map and the amount of trust that exists between a node of a social map and the server/repository that stores and maintains the social map.

The following sections describe establishing these levels of trust within a social map.

A. Establishing Trust Between Nodes of a Social Map

Each node of the social map typically represents an associated entity such as a user or a business. When one node wishes to see or connect to another node in the map, there are certain trust policies that need to be honored before such a connection can be made. The system of the present invention establishes, measures, and quantifies trust between two nodes of a social map.

1) Constructing a Social Network

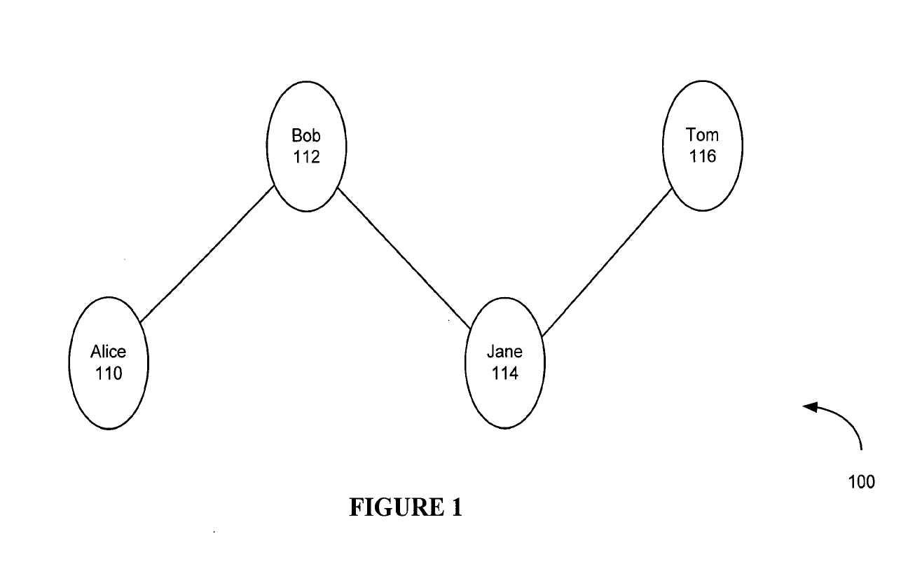

For example, FIG. 1 illustrates a simple social network map 100 involving four friends, Alice 110, Bob 112, Jane 114, and Tom 116. In FIG. 1 and other figures illustrating social network maps, each circle with a caption represents an associated entity in the social network, represented as a node on the social network map. For example, the node labeled “Alice” stands for an individual who is known as Alice in this social group. A line segment between two circles represents a direct social relationship between the two associated entities in the social network. In the social network illustrated in FIG. 1, Alice 110 knows Bob 112 directly, Alice 110 knows Jane 114 through Bob 112, and both Alice 110 and Bob 112 know Tom 116 through Jane 114. This social relationship can be described as:
Alice-Bob-Jane-Tom

A system of the present invention registers a list of all associated entities, including a list of all Alice's friends, a list of all Bob's friends, a list of all Jane's friends, and a list of all Tom's friends, resulting in a personal trust network map resembling a star constellation with many nodes and social relationships. The system may store that information in a repository, such as a server, that maintains a dynamic list of the trust relationships.

For illustrative purposes, consider an embodiment of the present invention that uses this mapped social network in a novel mechanism to combat SPAM (unwanted e-mail). If e-mail is sent by a friend, a friend of a friend, or a friend of a friend of a friend, and so on, it is less likely to be SPAM.

Upon the receipt of an e-mail, the e-mail application used by the recipient queries a repository to see if the sender's e-mail address matches anyone in the recipient's personal trust network and determines if the e-mail passes his SPAM filtering criteria. If it does, the e-mail is permitted to pass into the inbox. However, if the e-mail is received from an e-mail address outside the personal trust network of friends, it is more likely to be SPAM. In that case, and in accordance with the recipient's preferences, the e-mail can be dealt with in another way, for example by moving the e-mail to a junk mail folder and the like.

Although FIG. 1 illustrates a situation where individual persons are mapped, the present invention applies equally to situations where each associated entity of Alice 110, Bob 112, Jane 114, and Tom 116 are devices, collections of devices, organizations, companies, corporations, sets of users, and the like. In this case, each device, organization, and the like would constitute an associated entity.

For example, the associated entity could be designated based on some attribute. A person interested in information pertaining to Russia, for instance, might want to receive e-mail sent from any Russian e-mail address. In this case, his associated entities could be the set of all senders with Russian addresses. In this example, the Russian e-mail address is the attribute that defines an associated entity. In FIG. 1, for example, the set of all persons with Russian e-mail addresses could be substituted for the associated entity Jane. In a variation on this example, Bob could decide that his friends are Jane and all of Jane's friends who also have a Russian e-mail address, or alternatively, all of Jane's friends who do not have a Russian e-mail address. In this fashion, Bob can decide who are his associated entities.

a) Social Network Map

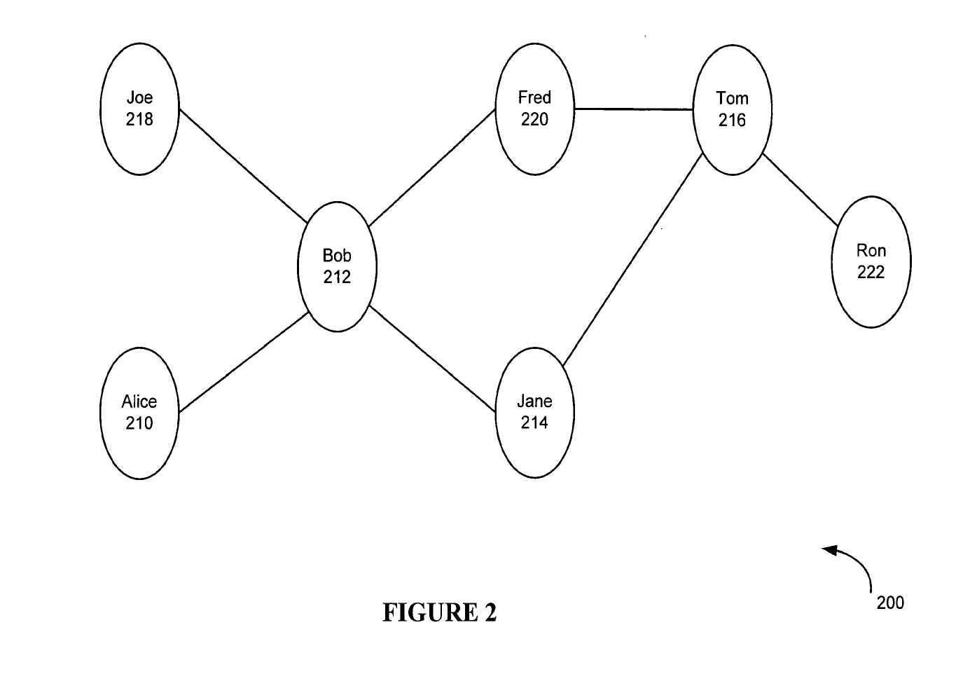

FIG. 2 depicts a social network map 200 of relationships among Alice 210, Bob 212, Jane 214, Tom 216, Joe 218, Fred 220, and Ron 222. Each individual in this social network map 200 constitutes a friend. In this social network map 200, the direct social relationships include Alice 210 and Bob 212, Joe 218 and Bob 212, Bob 212 and Fred 220, Bob 212 and Jane 214, Fred 220 and Tom 216, Jane 214 and Tom 216, and Tom 216 and Ron 222. These direct relationships have an inherent degree of trust.

FIG. 2 also depicts several indirect relationships. For example, Alice 210 and Fred 220 are connected socially through Bob 212, their mutual friend. Similarly, Bob 212 and Tom 216 are connected socially through two mutual friends, Jane 214 and Fred 220. The degree of trust between nodes can be determined and quantified by the associated entities of this social network map.

The notation H(a,b) represents the number of hops between two nodes, a and b, within a social network map. For example, H(Alice, Bob) is equal to one, and H(Alice, Tom) is equal to three.

2) Assigning Social Distance

Social distance can be used to set a fuzzy trust policy for a variety of applications. It can be a subjective measure. A fuzzy trust policy recognizes more than simple true and false values. With a fuzzy trust policy, propositions may be represented with degrees of trust based upon the social distance. Social distance is a value assigned by one associated entity, A, to a directly-connected associated entity, B, within a social network to reflect the degree of trust that A has in B. Social distance is directional and asymmetrical. The social distance from A to B and the social distance from B to A are not necessarily identical, or even correlated. The former is assigned by A based on his degree of trust in B. The latter is assigned by B based on his degree of trust in A. To properly model behavior, the system of the present invention permits directional and asymmetric trust relationships.

Social distance must be measurable and ranked. The simplest form of social distance can be specified with numerical values. For example, a system may define its social distance as a value between 1 and 10, where 1 indicates the strongest degree of trust. If a friend, A, is extremely close to his directly-connected friend, B, in a social network map, A may assign a value of 1 as the social distance from A to B. However, if another individual, C, is merely an acquaintance of A, then A may assign a social distance of 10 from A to C. The notation SD(A,B) represents the social distance from A to B. In the example above, SD(A,B) is equal to 1 and SD(A,C) is equal to 10. More complicated or involved methods of identifying social distance may also be used.

In an exemplary embodiment of this invention, associated entity A may change social distance. For example, if company A and company B are business partners, company A may assign a social distance of 1 to any e-mail originating from company B. If the two companies cease to be business partners, company A may want to increase the social distance. Indeed, if the relationship becomes hostile, company A may want to ban contact with company B. In the present invention, the degree of trust can be set to designate no trust, with the result of banning all e-mail coming into company A from company B.

Optionally, a third party may assign a social distance between two individuals. For example, suppose A assigns a social distance from A to B of 1, and B assigns a social distance from B to C of 1. In this optional embodiment, if A is dissatisfied with a social distance of 1 from B to C—for example, if A distrusts C—A can set the social distance from B to C to 10. This change would not override B's assignment of 1 for B's social network. The social distance set by A would apply only to A's social network. Thus, in this embodiment, it is possible to have more than one social distance for one direction of a direct connection.

In another alternative embodiment of the present invention, a user's assignment of a social distance may be overridden. For example, within an enterprise, it may be desirable to override a user's assignment and force a new social distance. A company could, for instance, decide that the social distance for all systems and users within the company and all systems and users with another company shall be 1, and that designation would override any social distance values assigned by individual users within the company.

a) Social Distance Map

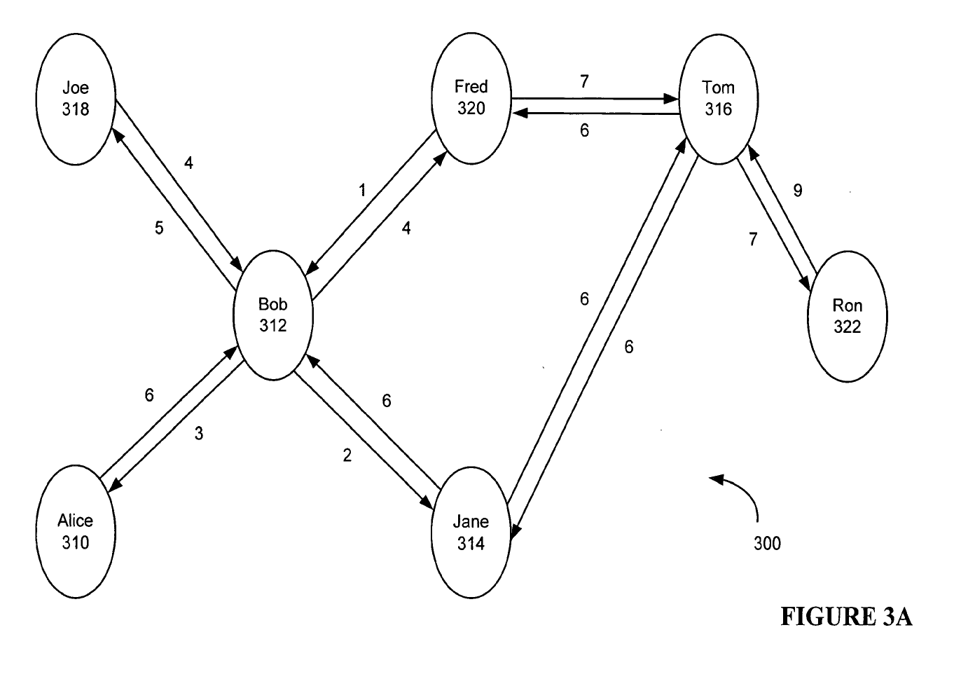

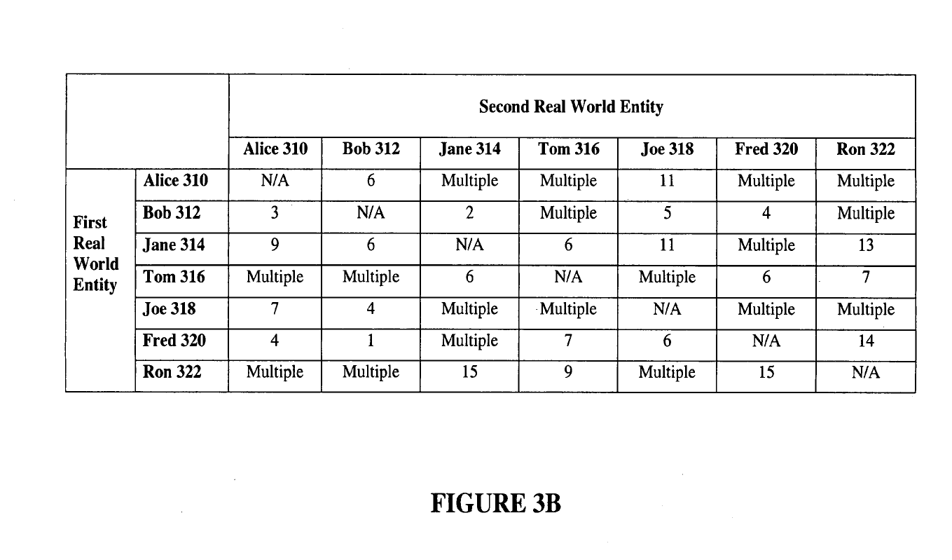

FIG. 3A illustrates a social distance map 300 that corresponds to the social network map 200 depicted in FIG. 2. A social distance map is derived from the social network map by incorporating social distance values. Instead of a line between two nodes to indicate a direct social relationship, a social distance map has two directional arrows between two nodes. A social distance value is associated with each directional arrow. In FIG. 3A, the nodes represent associated entities, such as individuals, Alice 310, Bob 312, Jane 314, Tom 316, Joe 318, Fred 320, and Ron 322. The directional arrow from Bob 312 to Joe 318 is labeled 5, indicating the social distance that Bob 312 assigned between himself and Joe 318. In other words, SD(Bob, Joe) is equal to 5. Similarly, SD(Alice, Bob) is equal to 6. The social distance map of FIG. 3A may be stored in a memory device in various formats, such as a lookup table or a database. An example of one such social distance map lookup table is shown in FIG. 3B.

3) Determining Trust Between Two Nodes in a Social Network

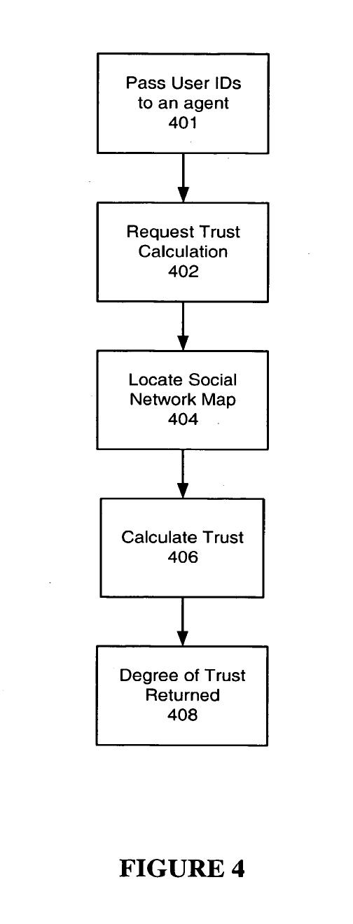

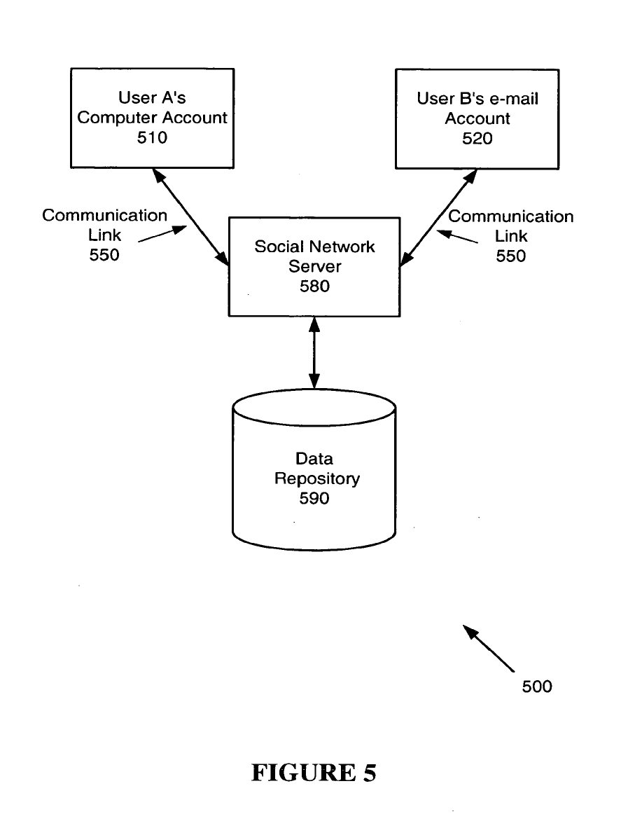

Once a social distance map is constructed, it can be used to calculate social distances as illustrated by the flow diagram of FIG. 4. The process of calculating those social distances is carried out by the system illustrated in FIG. 5.

In FIG. 4, the process begins in step 401 where User A's and User B's IDs are passed to an agent such as a server. In step 402, the server is asked to calculate the trust between A and B. In step 404, the server locates the social network map that contains the Users A and B. The initial trust between two individual nodes on the social network map is zero until a link is found. The calculation and quantization of trust is based on the number of hops, the social distance, or both. The number of hops may be the number of line segments that must be traversed to move from one node (first real world entity) to another node (second real world entity).

In step 406, the server calculates the trust, and the calculated value is communicated back from the server. At step 408, the degree of trust is returned, and this social distance measure can be used as a trust policy setting in applications such as SPAM control, file sharing, and the like.

The notation T(a, b) represents the degree of trust that a has in b. The degree of trust between the two nodes can be determined based on the number of hops, the social distances, or both the number of hops, H(a,b), and the social distance, SD(a, b), between the two nodes using a variety of mathematical and logical methods, some of which are explained below. For example, in FIG. 3A, Bob 312 is directly connected to Fred 320, and Fred 320 is directly connected to Tom 316. So, T(Bob, Tom) can be determined based on the values of H(Bob, Tom), or by SD(Bob, Fred), and SD(Fred, Tom). However, in FIG. 3A, Bob is also directly connected to Jane, and Jane is directly connected to Tom. So, T(Bob,Tom) can be determined based on the values of H(Bob, Tom), SD(Bob, Fred), SD(Fred, Tom), SD(Bob, Jane), and SD(Jane, Tom). As noted above, an example of one such social distance map lookup table is shown in FIG. 3B.

The mathematical method of determining a degree of trust can be instituted globally by using the same method for all nodes in a social network map, or it can be customized based on individual or group preferences, for example.

As mentioned previously, a social network or an associated entity may use a wide variety of mathematical methods to determine T(a, b) when a and b are not directly connected. These mathematical methods include an associated entity determining the degree of trust based solely on the number of hops, H(a, b), without considering social distances. In the above case, T(a, b) is equal to H(a, b).

Additionally, an associated entity may determine the degree of trust by summing up one set of social distances between two nodes. In the example above, T(Bob, Tom) is equal to the sum of SD(Bob, Fred) and SD(Fred, Tom), since Bob 312 is directly connected to Fred 320 and Fred 320 is directly connected to Tom 316.

An associated entity may also determine the degree of trust based on both the number of hops and social distances. In this case, a node may be trusted if H(a, b) is less than a value M AND SD(a, b) is less than a value N. The AND in this formulation represents a logical AND.

Further, an associated entity may derive a method to manage the situation where multiple intermediate nodes exist, such as the case illustrated in FIG. 3A where both Fred 320 and Jane 314 are represented as intermediate nodes between Bob 312 and Tom 316. One possible method is to average the sums of social distances. Specifically, using the previous example, T(Bob, Tom) equals to the average of the social distances represented by both alternative routes. In the example of FIG. 3A, to compute this social distance, we first determine the sum of the social distance between Bob 312 and Fred 320 (that is, 4) and the social distance between Fred 320 and Tom 316 (that is, 7). The sum of this first route is 11. Next, we determine the sum of the social distance between Bob 312 and Jane 314 (that is, 2) and the social distance between Jane 314 and Tom 316 (that is, 6). The sum of this second route is 8. The average of the two computed social distances between Bob 312 and Tom 316 equals the average of the sum of the two routes. That is, (11+8)÷2 equals 9.5. Using this method, then, T(Bob, Tom) equals 9.5.

Likewise, an associated entity may calculate the degree of trust using Dijkstra's shortest distance algorithm or other similar methods.

Also, an associated entity may determine the trust relationships when no trust has been specified. For example, an associated entity may determine the trust relationships when a node does not exist yet on the social map or no path of connection exists between two nodes on the social map. In an optional embodiment of the present invention, for example, a trust model may be established where no e-mail related to the node is trusted regardless of the other determining factors present. Alternatively, the handling may be such that all e-mail is deemed trusted regardless of the other determining factors present.

Embodiments of the present invention may use any mathematical or logical methods to determine degrees of trust based on the number of hops between nodes, the social distances between nodes, both the number of hops and the social distances, or one or both of these parameters in combination with other parameters such as personal preferences or corporate policies.

B. Improving Trust Between the Social Network and its Users

Social networks often contain extremely sensitive information. Associated entities that supply information to the network need to be able to govern the use of the data that they contribute. Associated entities will be reluctant to release information such as e-mail addresses, home addresses, and the like, if they have no control over who sees or who can use that information. The present invention provides techniques and approaches to enable owners of the data to govern the use of their information.

1) Opt-In

One concern about the abuse of a social network is that a node will be created for an entity who has not agreed to participate in the social network. Typically, this concern is addressed by allowing an associated entity to create only a node that represents him. If an associated entity wishes to map a relationship to an entity that is not part of the system, that relationship is not allowed in the system's trust policy and will not be entered.

For example, suppose User A has a Friend B. Friend B does not want to publish his information, but User A wants to have a complete social network. So User A publishes information about Friend B. In the system of the present invention, the database may allow information to be entered, but the information is not made available to anyone, because Friend B's node does not have an authorized owner that has agreed to opt in. The social network of the present invention would hold the information but not allow its disclosure until Friend B agrees to opt-in.

2) Decentralized Network

Any social network that is centralized on a given server may not be fully trusted by users. If the owner of the central repository decides to permit “illegal” snooping of the social network map by untrusted outsiders, a user of the social network that has agreed to contribute information may feel that their privacy has been violated.

One approach to minimizing this risk is to decentralize the social network. In this scenario, each information owner would cryptographically protect their information. Only associated entities that they trust and consider friends would have access to the data. In this case, when one node wishes to establish a link to another node, the nodes may enter into a mutual agreement. If there were an agreement between the nodes, the keys to unlock the information on both nodes would be exchanged. User A may set a policy that states that keys to his information may be shared with nodes up to 2 hops away. In this model, the owner of data on the network retains control over the information.

3) Management of the Links

A node in the social network may establish policies about the kinds of links that can be made to it. For example, User A may establish a link policy stating that if User B wishes to add User A as a friend on User B's friends list, then User A must approve and declare User B as a friend. In this model, there would be no “one way” friendships.

In addition, a trust policy may state that either User A or User B may remove the friendship link, but that no one else is authorized to eliminate the link. In addition, there would need to be an agreed-upon policy about editing the link parameters that identify information about the relationship. Both User A and User B would need to agree to the policy, as it is considered shared information between them. Example link parameters and designations might include “professional,” “real-life friend,” “life-long friend,” “close relative,” “distant relative,” “online buddy,” and the like.

4) Management of the Data

In some cases, other associated entities of the social network may want to declare an opinion about the legitimacy of a link or node. Because a social network is a shared system, not all data in the network is going to be legitimate. One way to implement the trust model between nodes is to allow the users of the network to vote on the legitimacy of any link or node.

If a user is introduced into the social network map and misrepresents their data or their links, other legitimate users can record their opinion of legitimacy of that data. A user's decision to accept the authenticity of a node or link may be determined by a policy based on other users' opinions of that link's legitimacy. For example, User A could establish a policy of not trusting any data (that is, not trusting any node or link) that has a legitimacy rating less than 5 on a scale of 1 to 10, based on average votes. A myriad of policies may be established based upon the number of nodes and links and the users' overall degree of trust they have in new nodes.

C. Social Network Design Considerations

A number of factors must be considered when designing the social network. A social network repository, social network classes, the effect of multiple social networks, and application-specific trust policies must all be considered when designing a social network.

1) Social Network Repository

Social network data, including the social network map, social distance map, hops, social distances, and the degree of trust, may be stored in a repository. The data stored in the repository is accessible by the individual, including agents operating on behalf of the individual.

The physical instantiation of the social network repository may be implemented in a variety of forms. For example, a repository may be a dedicated Internet service to serve a social network or a single logical service with a physically distributed database. Additionally, a repository may be implemented as a set of distributed personal databases, where a personal database is designated for each node in the social network and the personal databases are sharable with other nodes. Also, a repository may be tethered to an existing social network service, such as Friendster®, Linkedin™, and Tribe®. In this case, a new data entry field to query the user for a social distance may be added to the existing social network service's “add friend” screen.

2) Social Network Classes

In addition to social networks such as Friendster®, Linkedin™, and Tribe®, that are designed for establishing friendship, the system and methods disclosed in the present invention apply to other classes of social networks, such as Internet services for family trees, class reunions, eBay buyers and sellers, residential communities, special interest groups, club memberships, and enterprise organizations. Different classes of social networks serve different purposes. For example, an individual may set up a trust policy to share his family reunion pictures up to the second cousins, as determined by the family tree network.

3) Multiple Social Networks

It is certainly possible for a user to belong to and to use multiple social networks to set up a trust policy. Similar to the multiple intermediate node example described above, a trust policy may be established to use all or parts of the hops and social distances from multiple social networks. However, the mathematical method to determine the degree of trust may vary based on network-wide or individual preferences. For example, a trust policy for SPAM filtering may use data from all of the social networks to which an individual belongs. On the other hand, a referral querying application for local handymen may use only the data from the residential community network.

4) Application-Specific Trust Policy

Different trust policies may be used for different applications or for different social network classes. For example, an individual may deploy a more stringent trust policy for a referral querying application and impose higher trust requirements than for an advertisement targeting application. In this case, the social network repository may store multiple sets of social distances and degrees of trust, one for each application.

Similarly, different social distances may be assigned by a user for use in different applications or with different social network classes.

### II. Exemplary System for Creating a Social Network Map and Social Distance Map

FIG. 5 depicts an example of an overall system 500 used to create a social network map that can be further used to assign social distances between two individuals who are part of the social network. Although e-mail accounts are shown as an example, many other applications are possible such as access control lists, file sharing, computer service sharing, and the like. Also, any computational decision may be based upon the trust relationship determined by the present invention. The exemplary e-mail system illustrated may be replaced with similar systems configured for the particular application environment.

The exemplary system 500 illustrated in FIG. 5 consists of a number of components. For example, User A's Computer account 510 represents a computer device used by User A (such as a PC or handheld device) to register with a social network server 580, and to specify his list of friends and the social distance he assigned between himself and each friend. User A's Computer account 510 is connected to the Social Network Server 580 via Communication Link 550.

Additionally, User B's E-mail account 520 represents an e-mail account of User B, who is listed as a friend by A. It is an e-mail account to which the Social Network Server 580 sends a confirmation query to ensure the relationships are accurate. The Social Network Server 580 is an application server that coordinates the creation of a social network map and also calculates or otherwise determines trust between two individuals upon request. The Social Network Server 580 has a web interface to interact with the users and a database interface to access the Data Repository 590 that is used to store the social network map and the social distance map. The Data Repository 590 stores the social network map and social distance map resulting from the above method. It is a software/hardware data repository used to store social relationship maps in data structures. The Communication Link 550 represents a channel of communication that can be embodied or realized in various forms such as point-to-point connections, intranets, and various private and public communication channels such as the Internet.

In this exemplary system 500, User A 510 visits the Social Network Server 580 using a web interface and registers his list of friends along with their assigned social distances. After registration, the Social Network Server 580 sends e-mails to e-mail accounts of the listed friends, including User B's e-mail account 520, asking them to confirm their relationships with User A and assign a social distance from themselves to User A. When one of User A's friends, such as User B, confirms the relationship, the Social Network Server 580 stores the social distance map in a Data Repository 540. This process of creating a social network map and creating a social distance map is detailed in the sections below.

A. Creation of the Social Network Map

A social network map and social distance map may be developed by a wide variety of mathematical methods or rules. For example, the social distance may be based on the number of hops between two users in a social network map. Social distance also may be assigned using rules based on the number of friends and friends-of-friends in the network. In this case, if two or more direct friends (that is, those friends connected directly to the user's node) have a mutual friend, that mutual friend would be assigned a lower (more trusted) social distance than a person who is the friend of only one direct friend.

Social distance also may be determined using rules based on some attribute of a friend. For example, company A could be included in the social network of all the users of its computers and all users of company B's computers. In that case, the relationship between an employee of company A and an employee of company B might be assigned a higher (less trusted) social distance than if company A had added a particular individual at company B to its social network.

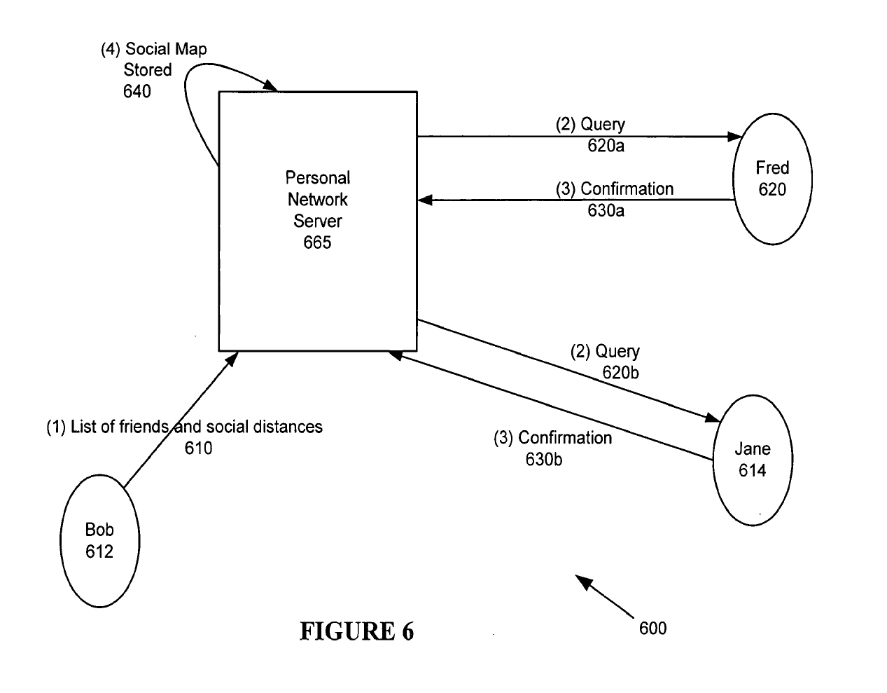

An exemplary embodiment is discussed in more detail below to highlight some of the variations in mechanisms that can be used to assign social distances. In this first embodiment, a centralized web-based repository handles the registration and storage of social relationships through a challenge and response mechanism. FIG. 6 illustrates an application of this embodiment to an e-mail-based network.

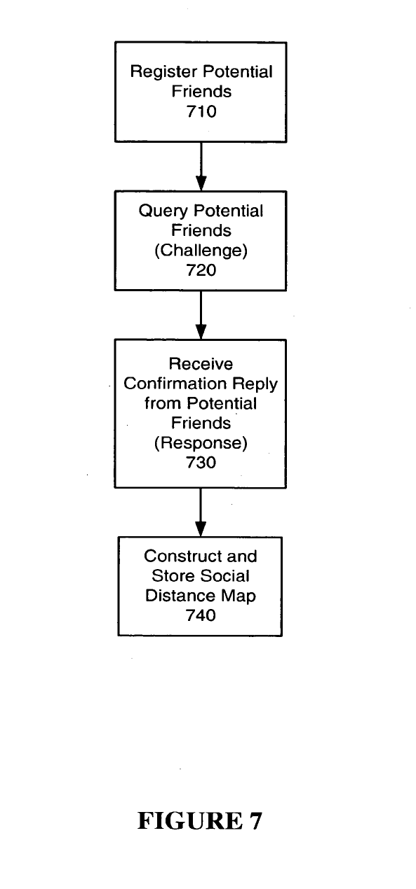

FIG. 6 and FIG. 7 provide two different graphical representations of the following challenge and response registration mechanism. FIG. 7 provides a process flow diagram illustrating the steps necessary to create the social network of FIG. 6.

In step 610, Bob 612 registers with the Personal Network Server 665. In the registration request, Bob 612 provides a list of friends that he trusts (Fred 620 and Jane 614) and assigns a social distance to each of the listed friends.

In 620a and 620b, the Personal Network Server 665 queries Fred 620 and Jane 614 by sending an e-mail to each asking for confirmation of their relationships with Bob 612. If such a relationship exists, the Personal Network Server 665 requests that Fred 620 and Jane 614 each assign a social distance value to their relationship with Bob 612.

In 630a and 630b, Fred 620 and Jane 614 each confirm that Bob 612 is indeed their friend, and they each assign a social distance to their relationship. The social distance values Bob 612 assigned to his relationships with Fred 620 and Jane 614 may be different from the social distance values that Fred 620 and Jane 614 assign. For instance, Bob 612 may assign a social distance of 2 to his relationship with Jane 614, but Jane 614 may assign a social distance of 6 to her relationship with Bob 612.

In 640, the Personal Network Server 665 uses the inputs from Bob 612, Fred 620, and Jane 614 to store a social distance map of the relationships among them in a data structure or database. As indicated above, an example data structure is shown in the table of FIG. 3B.

FIG. 7 illustrates a challenge and response registration mechanism in a flow diagram showing registration of friends and social distances by an initiating node in step 710, querying of potential friends to provide confirmation e-mails regarding their relationship with the initiating node (challenge) in step 720, confirming the queried node's relationship with the initiator by replying via e-mail (response) in step 730, and constructing and storing the social distance map in step 740.

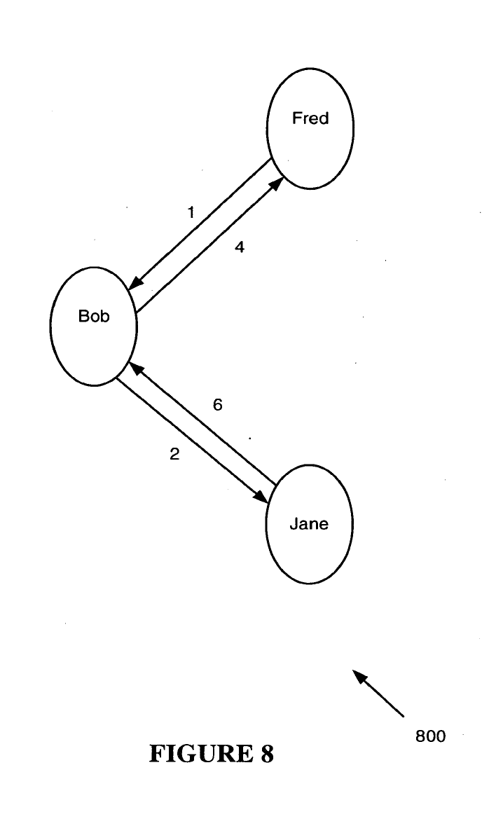

FIG. 8 shows the social network map 800 created using the process illustrated in FIG. 6 and FIG. 7. The social network map 800 is drawn with the assigned social distances between the pairs Bob-Fred (4), Fred-Bob (1), and Bob-Jane (2), Jane-Bob (6).

In an alternative embodiment, a social network map is created based on rules. These rules can be defined in various ways, depending on the needs of the individuals within the social network. In addition, the rules used to assign social distance may interact to refine the social distances that are assigned. The rules may be stored on a computer-readable medium as data structures and may be applied by a computer in an automated manner to construct the social network maps.

For example, a rule may assign social distances based on the security features offered by various devices at each node. Specifically, a device with a low security level gets a high (untrusted) social distance and a secure device gets a low (trusted) social distance. However, a different rule that assigns social distances based on another device attribute could interact with this rule. For instance, if the secure device has another attribute such as the capability to export digital content to which this different rule applies, the secure device maybe assigned a higher social distance, decreasing the amount of trust in that device.

Additionally, a rule may stipulate a low (trusted) social distance between the president of a company and each company employee, which results in communication from the president to the employees receiving high priority.

Also, individual users or groups of users may be allowed to refine general rules to create more specific rules that assign different social distances between themselves and others within their own social networks.

B. Applications of Computer-Modeled Social Maps

Computer-modeled social maps have many different applications. They may be used to create real-world relationships, to generate new customers for a business, to create new relationships between people who live near each other, to allow privileged access to computing services and digital goods, and the like.

1) Creating Real-World Relationships

Products like Friendster® are targeted at creating new real-world relationships. In these types of applications, a user joins a service as a consumer and provides relationship information to the server. The server then adds this information to a social network map and makes the social network map available to subscribers. The subscribers then may use the map to find new relationships based on existing relationships. In addition, these services may facilitate the creation of the social network map by providing communication tools and information about the user.

As shown below, the method of the present invention may be used to extend applications of computer-modeled social maps whose purpose is to establish real-world relationships.

a) New Customers for Businesses

A social map may include businesses that a given participant patronizes, and a business may list its customers. This enables a number of mechanisms for bringing new customers to a business including consumers finding new businesses to patronize by exploring the businesses that their friends use as well as businesses identifying new customers by attempting to contact friends of customers with whom the business has good relationships as determined by the method of the present invention.

An application that may employ this methodology is advertisement targeting. An individual may distribute advertisement or distribution materials to his closest circle of trusted peers. He may then expand the distribution to a wider circle of trusted peers as required.

An additional example is an online auction application that evaluates the seller's trustworthiness based on feedback from previous buyers. The trustworthiness may be more deterministic and personalized by overlaying a trust policy based on social distance as constructed by the present invention.

Another scenario that may capitalize on the method of the present invention is product recommendations. It is natural for an individual to place a higher value on a referral from a trustworthy source. For example, if a trustworthy peer recommends a movie, a music album, an electrician, or a stock, it is more likely for another individual to accept such a referral and acquire the referred resources or services than they would if there were no referral or if the referral came from an anonymous source. Therefore, a referral is a well-suited scenario for a trust policy based on social distance as performed by the present invention. An individual may query peers within a certain degree of trust for a referral. In addition, an individual may evaluate a referral based upon the degree of trust in the person making that referral. For example, if an individual receives referrals to multiple service providers for the same service, the one recommended by the peer with the highest degree of trust is most likely to be accepted.

To implement these types of applications, social maps need to include business or corporate nodes, and users would associate themselves with a new relationship marker, such as “client of” This relationship may have parameters such as age of the relationship, quality of the relationship, and the like.

b) New Relationships Between People Who Live Near Each Other

Social maps can also serve as a way to meet real-world neighbors. The goal of this application is to find ways to improve relationships between people that live and work near each other. In this scenario, users query the social map for information such as who would be a good candidate for carpooling, or if there any people that live near each other that enjoy fishing as a hobby. Additionally, users may query the social map to obtain e-mail addresses of the people that live in their community.

In addition, this application may disseminate information about community concerns such as local hazards, local politics, lost animals, services available in the neighborhood, block parties, opportunities for collective purchases, and the like.

If a social map includes work location, home location, hours of work, hobbies, e-mail addresses, phone number, and the like, the social network map may provide relevant information to interested parties.

c) Allowing Privileged Access to Computing Services and Digital Goods

A computer-modeled social network map enables users to regulate access to their networked services and digital works. With a reliable social network map, a user may expand his ability to govern the use of digital works and services that they own by permitting or denying access based on a social network map. Example digital works and services are printers, e-mail boxes, telephones, instant messaging, files/file shares, virtual environments such as games, and digital works including MP3 files, MP4 files, Windows Media files, and other computer documents and files. A computer-modeled social network map may instantiate social distances to provide different levels of rights based upon the social distance of the node. For example, a node with a short social distance (high degree of trust) may have rights to view, edit, copy, and print a digital work while a node with a higher social distance (lower degree of trust) may have only the right to view the digital work.

As described below, the system and method of the present invention may be applied to applications that focus on using social network maps to control access to computing services and digital goods.

The present invention provides a mechanism to combat SPAM (unwanted e-mail). E-mail sent by a friend, or a friend-of-a-friend, or a friend-of-a-friend-of-a-friend, and so on, is less likely to be SPAM than e-mail received from an unknown source. The present invention may be used to filter e-mail so that messages are treated differently depending on whether they are from a source within a specified degree of trust or outside a specified degree of trust. For example, e-mail from a source within a trust circle may be accepted and those from outside the circle may be automatically moved to a junk e-mail folder.

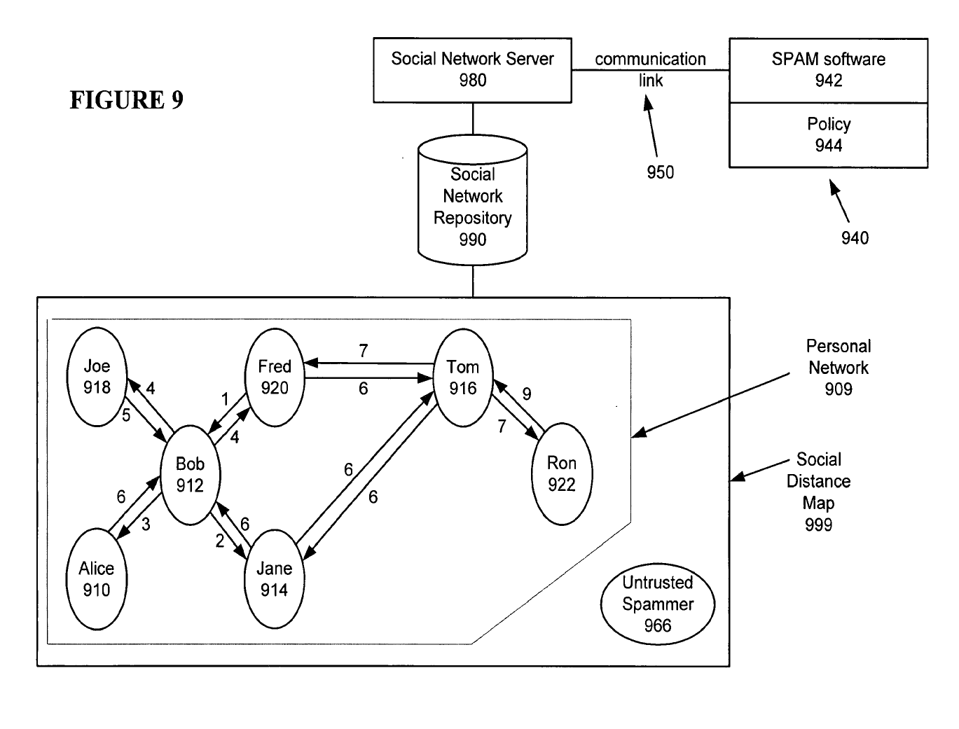

FIG. 9 illustrates an example schematic of a SPAM filtering system that uses a social distance map on a remote server to detect SPAM e-mails. In this system, a social distance map 999 of a network of friends comprising Joe 918, Bob 912, Alice 910, Fred 920, Jane 914, Tom 916, and Ron 922 is stored in a social network repository 990 accessible by the social network server 980.

As shown in FIG. 9, Joe's Computer 940 is the computer Joe 918 uses to access his e-mail. The computer 940 houses the SPAM Software 942 and a policy configuration setting 944. Joe's Computer 940 is connected to the Social Network Server 980 via a Communication Link 950.

Additionally, the SPAM Software 942 monitors an e-mail account to which the Social Network Server 980 sends a confirmation query. The policy 944 represents a policy setting by the user (Joe in this example) regarding the trust policy for determining whether an e-mail is SPAM. In this example, Joe 918 has set a strict trust policy dictating that an e-mail is SPAM if it is from any individual or node more than three hops away or has a social distance value greater than ten.

The Social Network Server 980 is an application server that interfaces with the Social Network Repository 990 that stores the social distance map 999. The Social Network Server 980 responds to queries from the SPAM Software 942 concerning the social distance and degree of trust between two nodes. Social Network Repository 990 stores the social network map, social distance map 999, hops, social distances, and the degree of trust. Communication Link 950 is a channel of communication that could be embodied or realized in various forms such as a point to point connection, an intranet, or an external network such as the Internet, and the like.

In the example of FIG. 9, if Joe 918 receives an e-mail from Bob 912, the premise is that it is probably not SPAM, because Bob 912 is a direct friend of Joe 918. Similarly, if Joe 918 receives an e-mail from Jane 914, it also unlikely to be SPAM, because Jane 914 is a friend of Bob 912 who is a friend of Joe 918. Anyone in this personal network 909 feels comfortable receiving an e-mail from anyone else in the network 909, since it is a network of commonly-trusted friends. However, if the e-mail is sent by the untrusted SPAMer 966 who lies outside of this social network of commonly trusted friends 909, the e-mail is considered to be SPAM and is therefore filtered out.

The trust policy regarding unsolicited email is based upon the social distance between nodes. The distance may be determined in many ways as previously described above. Alternatively, individuals may set policies on their e-mail clients so that only e-mails from nodes within a certain number of hops are allowed. All messages from nodes more than n hops away are considered SPAM. Thus, as shown in FIG. 9, if Joe 918 decides to implement an alternative policy and to accept only e-mails from nodes less than three hops away, he will not accept e-mail from Ron 922.

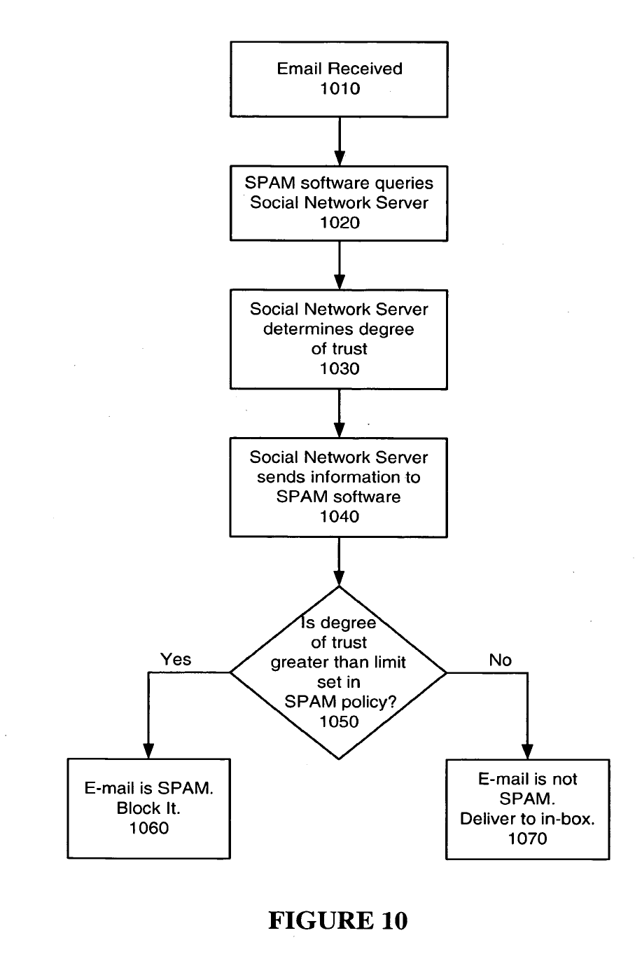

FIG. 10 illustrates a method that can be used by the SPAM software 942 to filter e-mails according to the policy setting 944 and the social distance queries sent to the server 980 in a system such as that of FIG. 9. As shown in FIG. 10, the process begins in step 1010 where Joe's email account 918 receives an email from Jane 914. In step 1020, Joe's SPAM Software 942 sends a query to the Social Network Server 980, querying about the degree of trust between Joe 918 and Jane 914.

In step 1030, the Social Network Server 980 determines the degree of trust based on the social distance map 999 from the Social Network Repository 990. In step 1040, the Social Network Server 980 sends this information to the SPAM Software 942 on Joe's computer 940. In step 1050, Joe's SPAM Software 942 determines whether the degree of trust is less than the limit stated in Joe's policy setting 944.

If the degree of trust is greater than the limit stated in Joe's policy setting 944, in step 1060 the e-mail is blocked as SPAM. If the degree of trust is not greater than the limit stated in Joe's policy setting 944, the e-mail is not considered to be SPAM, and in step 1070 it is delivered to Joe's inbox.

In an alternative embodiment, the present invention may be applied to manage and control access to a resource. For example, a user may want to allow a certain friend and friends of that friend to remotely access the user's computer and to use his computer files. For instance, a candidate for office may want to allow any of his party's campaign contributors to access his web site and post comments. The candidate may want to allow any friend of any contributor to access the site and view comments but not post comments. The friends of the user have different usage rights to the digital resource based upon their relationship to the user. The relationship is embodied by the social distance between the user and each friend, where shorter social distances are indicative of higher degrees of trust and are therefore permitted greater usage rights. Conversely, relationships with larger social distances are indicative of lower degrees of trust and are therefore afforded lesser usage rights.

In another example, a social network map may be used to manage access to shared services or products, such as devices. For instance, a user may want to allow his friends or friends of his friends to use his printer.

Likewise, the system and method of the present invention may be used to enable resource sharing. Conventional peer-to-peer networks such as KaZaA™ and eDonkey™ connect random, anonymous user machines in an ad hoc manner. The preferred peer-to-peer network architecture of the present invention connects user machines using a trust policy based on social distance to govern the connection. In this scenario, a client software application maintains persistent physical connections with other client software applications running on peer machines only when the trust policy is satisfied.

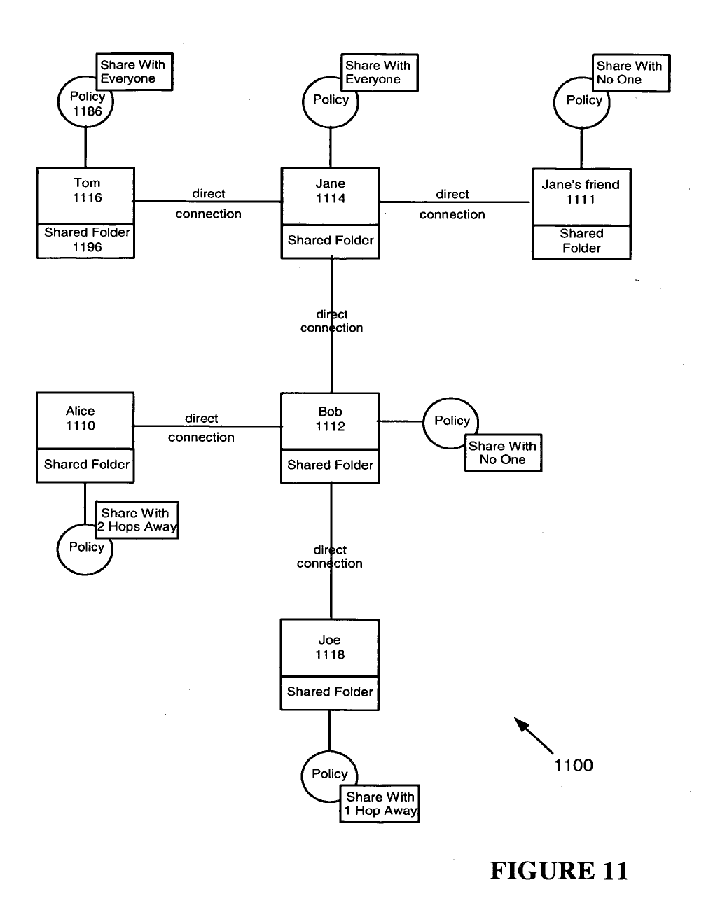

FIG. 11 illustrates the nodes of the network 1100 with client applications running on each machine. For example, the node labeled Tom 1116 represents a client application running on Tom's machine that maintains a direct connection with his friend Jane's client application. As shown in FIG. 11, Tom 1116 is connected to his friend Jane 1114, who is connected to her friend Bob 1112, and Jane's friend 1111. Bob 1112 maintains a persistent connection with his friends Alice 1110 and Joe 1118. A shared folder 1196 resides on Tom's machine that is exposed to this social network 1100. Tom 1116 may control sharing of his files using a policy 1186.

The nodes in a conventional peer-to-peer file sharing network are anonymous and are connected in a random way. The network topology in the social network 1100 illustrated in FIG. 11 is governed using a trust policy based on social distance. Using this type of network, there is an inherent level of trust among the nodes. Friends can share documents directly without worrying about exposing the documents to the rest of the world.

In addition to machine and file sharing in a peer-to-peer network, a trust policy based on social distance may be used in other types of resource-sharing scenarios. For example, an individual may leverage the trust policy to govern the sharing of his privacy information or personal data. Also, in a grid computing environment, which enables multiple computers to collaborate on a computing project, the trust policy may be used to govern the participating computers.

The present invention may be implemented by a general purpose computer programmed to accomplish the disclosed functions. Accordingly, the modules described herein may be implemented as computer hardware and/or computer software. Various devices may be used to provide the computer or computer system for effecting the invention.

While the present invention has been described in connection with a number of exemplary embodiments and implementations, the present invention is not so limited but rather covers various modifications and equivalent arrangements which fall within the purview of the appended claims.

What is claimed is:

1. A computer-implemented method, executed by one or more computing devices, for using social relationships between entities to provide access to a computing resource, the method comprising:
receiving, by at least one of the one or more computing devices, a request to calculate a social distance between a first node and a second node of a social map, the first node corresponding to a first entity, the second node corresponding to a second entity;
determining, by at least one of the one or more computing devices, a social distance between the first node and the second node based at least in part on one or more social connections between the first node and the second node;
determining, by at least one of the one or more computing devices, a trust relationship between the first entity and the second entity based at least in part on the one or more social connections between the first node and the second node; and
transmitting, by at least one of the one or more computing devices, information associated with the trust relationship to at least one of the first entity and the second entity, the trust relationship being used to determine whether the first entity is permitted to access a computing resource associated with the second entity.

2. The method of claim 1, wherein the predetermined trust level comprises more than a Boolean determination of trust level.

3. The method of claim 1, wherein the first node and the second node and the social connections between the first node and the second node are received from an existing social network computing application.

4. The method of claim 1, wherein the computing resource is a digital work and access is in accordance with a usage right associated with the digital work.

5. The method of claim 1, wherein the trust relationship levels are determined by the geographic location of the first entity and the second entity.

6. The method of claim 1, wherein the computing resource comprises a neighborhood e-mail network.

7. The method of claim 1, wherein the computing resource comprises a ride sharing network.

8. The method of claim 1, further comprising incorporating a trust policy into an application that evaluates trustworthiness based upon feedback from previous interactions, whereby trustworthiness will be more deterministic and personalized.

9. The method of claim 1, wherein the computing resource of the second entity is an email inbox and the access includes sending an email message to the email inbox, whereby the method serves as an email filter.

10. An apparatus for using social relationships between entities to provide access to a computing resource, the apparatus comprising:
one or more processors; and
one or more memories operatively coupled to at least one of the one or more processors and having instructions stored thereon that, when executed by at least one of the one or more processors, cause at least one of the one or more processors to:
enable the receipt of a request to calculate a social distance between a first node and a second node of a social map, the first node corresponding to a first entity, the second node corresponding to a second entity;
determine a social distance between the first node and the second node based at least in part on one or more social connections between the first node and the second node;
determine a trust relationship between the first entity and the second entity based at least in part on the one or more social connections between the first node and the second node; and
transmit information associated with the trust relationship to at least one of the first entity and the second entity, the trust relationship being used to determine whether the first entity is permitted to access a computing resource associated with the second entity.

11. The apparatus of claim 10, wherein the predetermined trust level comprises more than a Boolean determination of trust level.

12. The apparatus of claim 10, wherein the first node and the second node and the social connections between the first node and the second node are received from an existing social network computing application.

13. The apparatus of claim 10, wherein the computing resource is a digital work and access is in accordance with a usage right associated with the digital work.

14. The apparatus of claim 10, wherein the trust relationship levels are determined by the geographic location of the first entity and the second entity.

15. The apparatus of claim 10, wherein the computing resource comprises a neighborhood e-mail network.

16. The apparatus of claim 10, wherein the computing resource comprises a ride sharing network.

17. The apparatus of claim 10, wherein the one or more memories have further instructions stored thereon that, when executed by at least one of the one or more processors, cause at least one of the one or more processors to incorporate a trust policy into an application that evaluates trustworthiness based upon feedback from previous interactions, whereby trustworthiness will be more deterministic and personalized.

18. The apparatus of claim 10, wherein the computing resource of the second entity is an email inbox and the access includes sending an email message to the email inbox, whereby the method serves as an email filter.

19. At least one non-transitory computer-readable medium storing computer-readable instructions that, when executed by one or more computing devices, cause at least one of the one or more computing devices to:
receive of a request to calculate a social distance between a first node and a second node of a social map, the first node corresponding to a first entity, the second node corresponding to a second entity;
determine a social distance between the first node and the second node based at least in part on one or more social connections between the first node and the second node;
determine a trust relationship between the first entity and the second entity based at least in part on the one or more social connections between the first node and the second node; and
transmit information associated with the trust relationship to at least one of the first entity and the second entity, the trust relationship being used to determine whether the first entity is permitted to access a computing resource associated with the second entity.

20. The at least one non-transitory computer-readable medium of claim 19, wherein the predetermined trust level comprises more than a Boolean determination of trust level.

21. The at least one non-transitory computer-readable medium of claim 19, wherein the first node and the second node and the social connections between the first node and the second node are received from an existing social network computing application.

22. The at least one non-transitory computer-readable medium of claim 19, wherein the computing resource is a digital work and access is in accordance with a usage right associated with the digital work.

23. The at least one non-transitory computer-readable medium of claim 19, wherein the trust relationship levels are determined by the geographic location of the first entity and the second entity.

24. The at least one non-transitory computer-readable medium of claim 19, wherein the computing resource comprises a neighborhood e-mail network.

25. The at least one non-transitory computer-readable medium of claim 19, wherein the computing resource comprises a ride sharing network.

26. The at least one non-transitory computer-readable medium of claim 19, further storing computer-readable instructions that, when executed by one or more computing devices, cause at least one of the one or more computing devices to incorporate a trust policy into an application that evaluates trustworthiness based upon feedback from previous interactions, whereby trustworthiness will be more deterministic and personalized.

27. The at least one non-transitory computer-readable medium of claim 19, wherein the computing resource of the second entity is an email inbox and the access includes sending an email message to the email inbox, whereby the method serves as an email filter.
